(19) United States
(12) Patent Application Publication
(10) Pub. No.: US 2022/0414254 A1
(43) Pub. Date: Dec. 29, 2022

(54) APPARATUS AND METHOD FOR FORMING CONNECTIONS WITH UNSTRUCTURED DATA SOURCES

(71) Applicant: Graft, Inc., San Francisco, CA (US)

(72) Inventors: Adam OLINER, San Francisco, CA (US); Maria KAZANDJIEVA, Menlo Park, CA (US); Eric SCHKUFZA, Oakland, CA (US); Mher HAKOBYAN, Mountain View, CA (US); Irina CALCIU, Palo Alto, CA (US); Brian CALVERT, San Francisco, CA (US); Deven NAVANI, San Jose, CA (US)

(21) Appl. No.: 17/735,994

(22) Filed: May 3, 2022

Related U.S. Application Data
(63) Continuation-in-part of application No. 17/488,043, filed on Sep. 28, 2021.
(60) Provisional application No. 63/216,431, filed on Jun. 29, 2021.

(51) Int. Cl. G06F 21/62; G06F 21/31; G06F 16/33; G06F 16/338

(52) U.S. Cl. CPC G06F 21/6227; G06F 21/31; G06F 16/3347; G06F 16/338

(57) ABSTRACT

A non-transitory computer readable storage medium with instructions executed by a processor maintains a collection of data access connectors configured to access different sources of unstructured data. A user interface with prompts for designating a selected data access connector from the data access connectors is supplied. Unstructured data is received from the selected data access connector. Numeric vectors characterizing the unstructured data are created from the unstructured data. The numeric vectors are stored and indexed.

### CROSS-REFERENCE TO RELATED APPLICATION

This application is a continuation-in-part of U.S. Ser. No. 17/488,043, filed Sep. 28, 2021, which claims priority to U.S. Provisional Patent Application Ser. No. 63/216,431, filed Jun. 29, 2021, the contents of each application are incorporated herein by reference.

### FIELD OF THE INVENTION

This invention relates generally to the processing of unstructured data. More particularly, this invention is related to techniques for forming connections with unstructured data sources.

### BACKGROUND OF THE INVENTION

Most of the world's data (80-90%) is Natural Data™: images, video, audio, text, and graphs. While often called unstructured data, most of these data types are intrinsically structured. In fact, the state-of-the-art method for working with such data is to use a large, self-supervised trunk model—a deep neural network that has learned this intrinsic structure—to compute embeddings—a dense numeric vector—for the natural data and use those as the representation for downstream tasks, in place of the Natural Data.

Unlike structured data, where rules, heuristics, or simple machine learning models are often sufficient, extracting value from Natural Data requires deep learning. However, this approach remains out of reach for almost every business. There are several reasons for this. First, hiring machine learning (ML) and data engineering talent is difficult and expensive. Second, even if a company manages to hire such engineers, devoting them to building, managing, and maintaining the required infrastructure is expensive and time-consuming. Third, unless an effort is made to optimize, the infrastructure costs may be prohibitive. Fourth, most companies do not have sufficient data to train these models from scratch but do have plenty of data to train good enrichments.

If you imagine the spectrum of data-value extraction, with 0 being “doing nothing” and 1 being “we've done everything,” then the goal of the disclosed technology is to make going from 0 to 0.8 incredibly easy and going from 0.8 to 1 possible.

The objective of the disclosed technology is for any enterprise in possession of Natural Data—even without ML/data talent or infrastructure—to get value out of that data. An average engineer should be able to use the disclosed techniques to deploy production use cases leveraging Natural Data; an average SQL user should be able to execute analytical queries on Natural Data, alongside structured data.

### SUMMARY OF THE INVENTION

A non-transitory computer readable storage medium with instructions executed by a processor maintains a collection of data access connectors configured to access different sources of unstructured data. A user interface with prompts for designating a selected data access connector from the data access connectors is supplied. Unstructured data is received from the selected data access connector. Numeric vectors characterizing the unstructured data are created from the unstructured data. The numeric vectors are stored and indexed.

### BRIEF DESCRIPTION OF THE FIGURES

The invention is more fully appreciated in connection with the following detailed description taken in conjunction with the accompanying drawings, in which:

FIG. 1 illustrates a system configured in accordance with an embodiment of the invention.

FIG. 2 illustrates processing to form an entity database in accordance with an embodiment of the invention.

FIG. 3 illustrates processing to form embeddings in accordance with an embodiment of the invention.

FIG. 4 illustrates query processing performed in accordance with an embodiment of the invention.

FIG. 5 is an interface for specifying a data source.

FIG. 6 is an interface displaying different connectors to different unstructured data sources.

FIG. 7 is an interface for specifying a connector and data access periodicity.

FIG. 8 is an interface for specifying an embedding for an unstructured data source.

FIG. 9 is an interface for specifying a connector and data access periodicity.

FIG. 10 is an interface for specifying a label.

Like reference numerals refer to corresponding parts throughout the several views of the drawings.

### DETAILED DESCRIPTION OF THE INVENTION

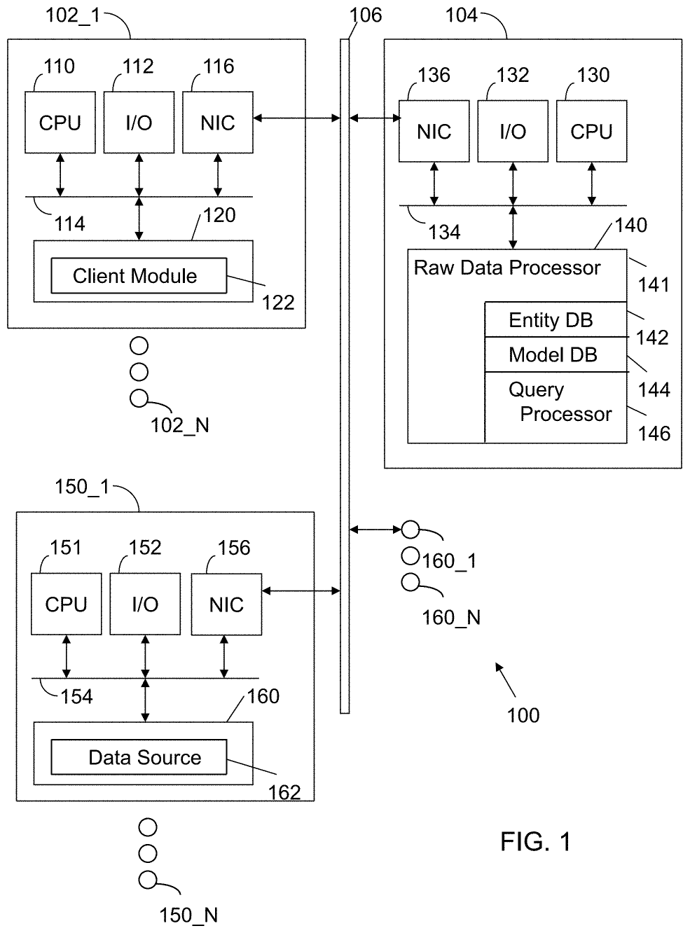

FIG. 1 illustrates a system 100 configured in accordance with an embodiment of the invention. The system 100 includes a set of client devices 102_1 through 102_N that communicate with a server 104 via a network 106, which may be any combination of wired and wireless networks. Each client device includes a processor (e.g., central processing unit) 110 and input/output devices 112 connected via a bus 114. The input/output devices 112 may include a keyboard, mouse, touch display and the like. A network interface circuit 116 is also connected to the bus 114. The network interface circuit 116 provides connectivity to network 106. A memory 120 is also connected to the bus 114. The memory 120 stores instructions executed by processor 110. The memory 120 may store a client module 122, which is an application that allows a user to communicate with server 104 and data sources 150_1 through 150_N. At the direction of the client module 122, the server 104 collects, stores, manages, analyzes, evaluates, indexes, monitors, learns from, visualizes, and transmits information to the client module 122 based upon data collected from unstructured data in images, video, audio, text, and graphs originally resident on data sources 150_1 through 150_N.

Server 104 includes a processor 130, input/output devices 132, a bus 134 and a network interface circuit 136. A memory 140 is connected to the bus 134. The memory 140 stores a raw data processor 141 with instructions executed by processor 136 to implement the operations disclosed herein. In one embodiment, the raw data processor 141 includes an entity database 142, a model database 144 and a query processor 146, which are described in detail below.

System 100 also includes data source machines 150_1 through 150_N. Each data source machine includes a processor 151, input/output devices 152, a bus 154 and a network interface circuit 156. A memory 160 is connected to bus 154. The memory stores a data source 162 with unstructured data.

The entity database 142 provides persistent storage for entities, labels, enrichment predictions, and entity metadata such as when an enrichment prediction was last made. The model database 144 provides persistent storage for trunks, combinators, enrichments, and metadata such as which user owns which model, when a model was last trained, etc.). The query processor 146 is a runtime process that enforces consistency between the entity and model databases, and provides UI access to both via a network connection. It also supports queries against entities, embeddings, machine learning embedding models and enrichment models, as detailed below. Each of these components may be implemented as one or more services.

The following terms are used in this disclosure:
Raw Data (also called Natural Data): Unstructured data, such as images, video, audio, text, and graphs in a native (non-augmented) form at the time of system ingestion.
Data Source: A user-specified mechanism for providing data to be processed. Examples include SQL tables, JSON or CSV files, S3 buckets and the like. FIG. 1 shows data sources 150_1 through 150_N.
Connector: A persistent service which pulls new data from a specified Data Source at regular intervals.
Entity: a time-varying aggregation of one or more pieces of data. For example, a user might define a “Product” entity that describes a commercial product to be all the images and videos associated with the product, a text description, user reviews, and some tabular values like price. As images or reviews are added or modified, the representation of that entity within the system also changes.
Primitive Entity: An entity defined in terms of a single piece of Raw Data. For example, an image or a single product review.
Higher Order Entity: An entity which is defined by combining multiple entities together. For example, the previously mentioned Product entity comprises image entities as well as text entities.
Embedding Model: A machine learning model that produces an embedding. This can be either a trunk model or combinator. Embedding models are applied to raw data or other embeddings to generate numeric vectors that represent the entity.
Trunk Model: A machine learning model that has been trained in a self-supervised manner to learn the internal structure of raw data. A trunk model takes raw data or as input and outputs an embedding, which is a numeric vector.
Combinator: A machine learned model or a process for combining the embeddings from multiple models into a single embedding. This is the mechanism through which the representations of multiple entities can be put together to form the representation of a higher order entity.
Embedding Index: A data structure which supports fast lookup of embeddings and k nearest neighbor searches (e.g., given an embedding, find the k closest embeddings in the index).
Enrichment: Refers either to a property inferred from an embedding or the model that performed that inference. For example, text could be enriched by a sentiment score.

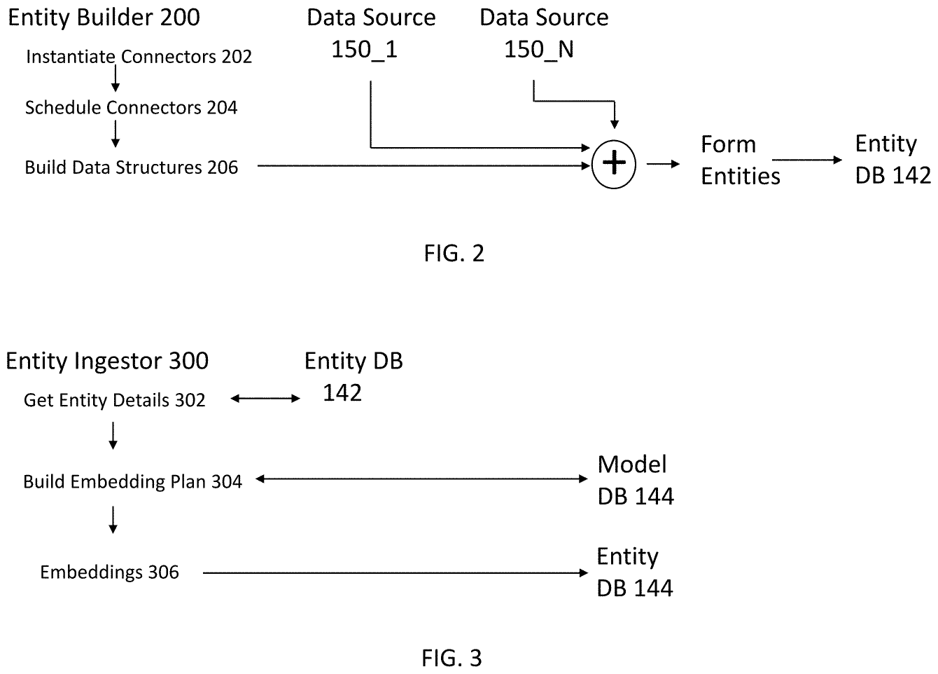

FIG. 2 illustrates the process to form the entity database 142. The raw data processor 141 includes an entity builder 200 with instructions executed by processor 130. The entity builder 200 instantiates connectors 202. That is, the user at client machine 102_1 logs into the raw data processor 141. If this is the first time, a unique username is created for the user. This information, along with metadata for the user account is stored in memory 140. A connection manager allocates storage space for connectors and schedules the times that the connectors are operative 204. The Entity Builder 200 allocates storage space for entities in the Entities database 142.

The entity builder 200 then builds data structures 206. In particular, the user clones or forks a model from a default user or another user who provides public models, such as in data sources 150_1 and 150_N. This makes these models available for use by the user. Storage for these models is allocated in a Model Database 144. Cloning and forking have different semantics (see below). A cloned model does not track the changes made by the user the model was cloned from. A forked model does. We note that when cloning or forking a model, it is not necessary to actually copy any bits. It only becomes necessary to do so for a forked model when a change is made to the model.

The user defines one or more connectors which point to their data (instantiate connectors 202). This data could be multi-modal and reside in very different data stores (e.g., an S3 bucket versus a SQL table). A Data Source is an abstract representation of a pointer to a user's data. Data Sources can contain user login credentials, as well as metadata describing the data (e.g., the separator token for a csv file). Once the user has configured a Data Source, that Data Source can be used to create a Connector.

In the processing of forming the entity database 142, the user forms one or more entities. An entity represents a collection of data from one or more Data Sources (e.g., Data Sources 150_1 and 150_N in FIG. 2). For example, a user might have a collection of photos in S3 and a collection of captions for those photos in a MySQL database. The entity representing a captioned photo would combine data from both of those data sources, as shown with the “+” operation in FIG. 2.

A user defines an entity by selecting Data Sources and describing the primary/foreign key relationships that link those data. The primary/foreign key relationships between these data sources implicitly define a table which contains a single row with data from each of its constituent Data Sources for each concrete instance of the entity. These relationships are defined by the build data structures operation 206 performed by the entity builder 200. Consequently, the entity has relational data attributes.

The Entity Builder 200 takes this description and uses it to instantiate Connectors 202 from the appropriate Data Sources (e.g., 150_1 and 150_N). The Entity Builder 200 also uses that description to create a table in the Entity database 142 (an explicit instantiation of the implicit concept described above). Rows in this table will hold all relevant entity data from the user's Data Sources and also system-generated metadata. Once the table has been created, the Connectors are handed off to a Connection Manager which schedules connectors 204 to periodically wake up. Once awake, the Connectors pick up changes or additions to the user's data.

The process of building data structures 206 involves the user defining one or more embeddings for each of their entities. This involves choosing a pretrained trunk model from the user's Model Database 144 or having the system select a model for them.

After the user or system selects a model, an Entity Ingestor 300 is invoked. The raw data processor 141 includes an Entity Ingestor 300 with instructions executed by processor 130. As shown in FIG. 3, the Entity Ingestor 130 gets entity details 302 from the entity database 142. In particular, the Entity Ingestor 130 is used to extract rows from the user's tables in the user's Entity Database 142. Those rows and the model choice are then passed to an Embedding Service, which builds an embedding plan 304 with reference to the model database 144. The Embedding Service uses a cluster of compute nodes (e.g., 160_1 through 160_N in FIG. 1) which pass the values from each row to the model and produce an embedding. The embeddings are then inserted into an Index Store associated with the Entity Database 144, and an opaque identifier is returned to the Entity Ingestor 300. The Entity Ingestor 300 then stores that identifier, along with metadata such as when the embedding was last computed in the Entity Database 142.

The user can optionally enable continuous pre-training for trunk models. This uses the data in the Entity Database 142 as inputs to an unsupervised training procedure. The flow for this process is identical to that of enrichment training. Supervised pre-training may also be utilized. For example, the trunk model may be updated with the aim of improving performance on one or more specific tasks.

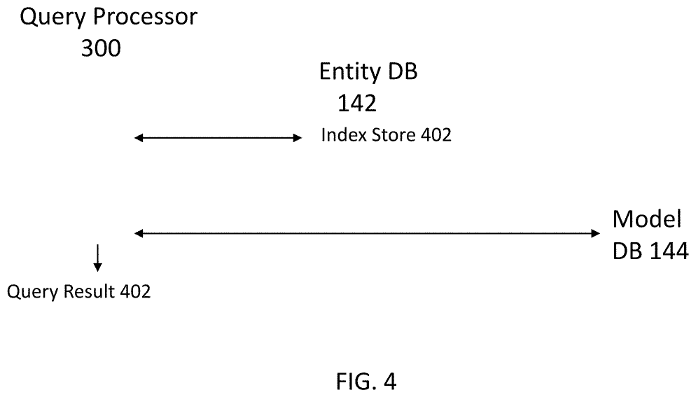

The user may at any point query the contents of the tables that they own in the Entity Database 142. This is done using a standard SQL client and standard SQL commands. The disclosed system provides SQL extensions for transforming the opaque identifier produced by the Embedding Service into the value it points to in the Index Store. These SQL extensions simply perform a query against the Index Store. FIG. 4 illustrates query processor 146 accessing Index Store 402 and the model database 144 to produce a query result 402.

The disclosed technology uses SQL extensions that allow the user to perform similarity queries. These are implemented using k-nearest-neighbor search. A SQL query which asks whether two entities are similar would be transformed into one which gets the opaque embedding identifier for those entities from the Entity Database 142 and then submits them to the Index Store 402. The Index Store 402 uses an implementation of K-nearest-neighbor search to determine whether the embeddings are within K neighbors of each other.

The user defines combinators which generate higher order entities from entities created using trunk models (e.g., an entity which represents a social media user's post history might be defined in terms of entities which define individual posts).

Once the user has defined a combinator, a new table is created in the Entity Database 142 (in the same fashion as described under Defining Entities above), and the Entity Ingestor 300 retrieves the entities from the Entity Database 142 which will be used to generate the higher order entity. The Entity Ingestor 300 extracts the embeddings for those entities (in the same fashion as described under Retrieving Embeddings above), computes a function over them (e.g., averaging the embeddings, concatenating them, or some other function that makes the most semantic sense for the higher order entity) and the new data is inserted into the Entity Database 142.

The user may attach labels to entities. This can be done via standard SQL syntax, as described below or through the web UI defining a data source for the labels. Disclosed below are SQL extensions for querying the set of entities for which label data would be most useful from the perspective of training enrichment models.

The user may define one or more enrichment models. An enrichment model is a machine learning model (e.g., multi-layer perceptron, boosted decision tree, etc.) which maps from entity embeddings to known values (such as semantic labels, or a continuously-valued target variable). Thus, an enrichment model predicts a property of an entity based upon associated labels.

Once a model has been defined it must be trained. This is orchestrated via a scheduler. Periodically, the scheduler activates a Fine Tuning Service. The service gets the enrichment model which must be trained from the Model Database 144. It then passes that model along with embeddings and labels it extracts from the Index Store 402 and Entity Database 142 to a Fine Tuning cluster (e.g., 160_1 through 160_N in FIG. 1). The compute nodes on the Fine Tuning cluster do the actual work of training the model. When they have run to completion, the Fine Tuning Service updates the persistent copy of the enrichment model stored in the Model Database 144.

Whenever an enrichment model is created, the raw data processor 141 also registers a prediction plan with a Prediction Scheduler. The prediction scheduler is run periodically or when new data or embeddings are available. It extracts an enrichment model from the Model Database 144 and passes it along with embeddings it has extracted from the Entity Database 142 to a Prediction cluster (e.g., 160_1 through 160_N in FIG. 1). The nodes in the Prediction cluster do the work of running inference on the models to produce a prediction. That prediction is then stored in the same row of the Entity Database 142 as the entity where the embedding used to generate the prediction is stored. Users may use standard SQL syntax to query predictions from the Entity Database 142.

Alerts based on predictions can be defined using standard SQL syntax. The user simply defines triggers based on the conditions they wish to track. Whenever an embedding or prediction which meets these conditions is inserted or updated in the Entity Database 142, the alert will fire.

SQL is typically used with relational (tabular) data. In such data, each column represents a type of value with some semantics. For example, a Name column would contain text representing a user's first name, middle initial, and last name. To work with unstructured data, specifically Raw Data augmented with embeddings, we require a few necessary SQL extensions, mostly related to administration, entities, similarity, and time. The SQL extensions and SQL processing are described in commonly owned, co-pending patent application Ser. No. 17/488,043, which was previously incorporated by reference. Entity processing is described in commonly owned, co-pending patent application Ser. No. 17/678,942. Attention is now directed toward elaborating on the previously defined connector.

Connectors are a bridge between two data storage methods, including the storage medium, format, or both. For example, a traditional connector (e.g., Fivetran®, DataCoral®, etc.) pulls data from a variety of sources into a relational database (i.e., the storage medium). Whereas the format at the source might be data fields exposed via an API or a file on disk with some internal structure, the format at the output is a table.

Traditional connectors do not work with unstructured data (e.g., images, text, video) due to several reasons: (1) Unstructured data tends to be bulkier and more cumbersome and copying it from one place to another is cost-prohibitive and (2) Relational databases do not traditionally handle unstructured data.

With the disclosed technology, the source format is Natural Data and the output format is embeddings. An embedding is a dense numeric vector representing a point in a high-dimensional space and a single entity (one or more units of Natural Data) may be represented by one or more embeddings and embedding spaces.

That data might originate from a similar variety of sources but may often be coming from a less structured source than traditional connectors are used to. Examples of data sources include cloud storage (e.g., AWS S3®), SaaS tools (e.g., Salesforce® or Zendesk®), or the public internet (e.g., social media such as LinkedIn® or Twitter®).

For instance, an entity representing a product might have two images and a text description. The text might be embedded using one model (Aₜₑₓₜ), while each image might be embedded using two models each (B_{img} and C_{img}), meaning the product would be represented by a total of 5 embeddings in 3 embedding spaces.

Given a raw object, like an image, the disclosed connector ingests the data from the customer data source and triggers the embedding(s) computation; the result is stored in an index (e.g., 402) and in a database (e.g., 142) along with the raw data ID and any associated metadata. Given a raw ID, the system (i.e., raw data processor 141) returns the object the ID refers to. If the raw data is stored in a third party datastore, the system manages credentials to authorize access to that data. The system also manages any models used to compute the above embeddings, including custom models supplied by the user.

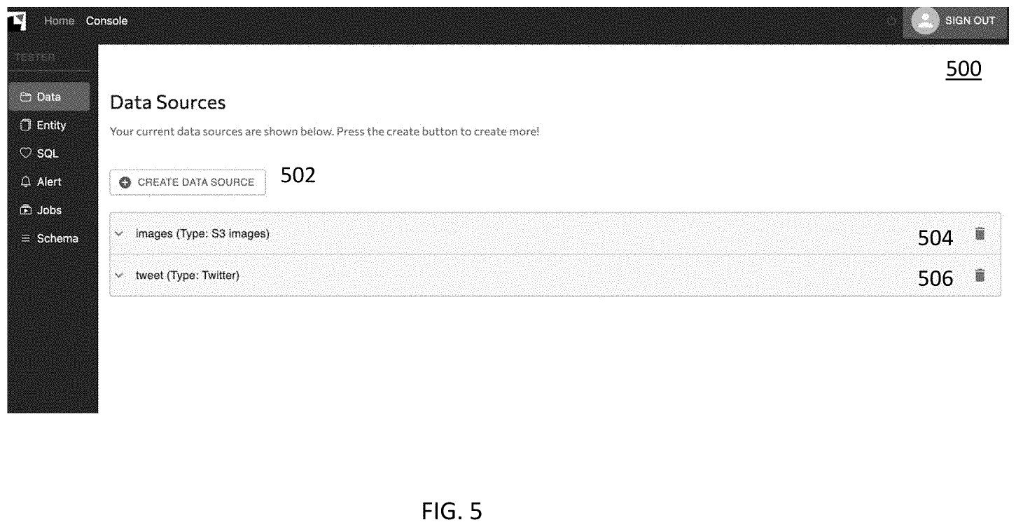

Configuring a connector is simple and requires the user to do the minimal amount of configuration. This is achieved by using default embedding models and configurations, making most data sources point-and-shoot. For example, for Zendesk®, the user would have to provide the credentials and select which data to index. Then the connector should be largely invisible to the user; data in connected sources will be reflected in the indexes. There is a lot of complexity hidden here. The main engineering challenge that the raw data processor 141 needs to solve to be successful is how to quickly and efficiently index high-velocity Raw Data or Natural Data. FIG. 5 illustrates an interface 500 that lists data sources. A user can create a data source by activating button 502. Subsequently, different data sources 504 and 506 are listed.

There is an explosion of new information being generated every day, with an exponential growth of data being created and stored. For example, in 2020 people were creating 1.7 MB of data every second, sending 306 billion emails and creating 500 million tweets every day. 80-90% of all the generated data is unstructured, which raises significant complexities when attempting to organize, sort or manage the data, extract useful information from the data, analyze it and generate actionable insights for businesses. In line with the data generation trend, Gartner estimates that more than 80% of enterprise data is also unstructured, with 95% of businesses citing unstructured data as a problem for their business.

Businesses have a sea of data generated by employees, customers, users or automatically by devices. Such data is critical for making business decisions and generating business insights, but it is difficult to organize, analyze and search for meaningful information, which could be sparse within the entirety of the available data. Unstructured data needs cleaning and significant transformations, but there is a significant lack of tooling and shortage of skills to process unstructured data. Unstructured data results in operational problems for business, due to large data volumes, high data velocity, lack of visibility and low standardization. Business insights can be hard or impossible to generate if the data is old or incomplete, or if using the wrong data.

In addition, increasing privacy regulations further fuel the pressure on businesses to properly organize and index all of their data, including unstructured data. For example, GDPR and CCPA require that businesses must be able to search and identify specific data related to users or customers, even if the data might not conform to any standard protocol.

The disclosed connectors address these problems that businesses are facing with Natural Data, which is any data that has a learnable structure and that can have associated models able to learn that structure to generate vector representations. Natural Data can be either structured or unstructured data, with the vast majority being unstructured.

The processor 141 provides a unifying approach to organizing, managing, indexing, searching and extracting meaningful insights for both structured and unstructured data. The connectors are tailored for a large variety of input data formats and storage mediums and output a unified format that simplifies data processing and analysis: embeddings. Embeddings are learned numerical vector representations of the data that capture semantic information from the input. The disclosed connectors ingest and transform customer-provided input data and power a variety of services, such as semantic search, label prediction and alerting.

The disclosed connectors address multiple challenges. First, the input data is extremely diverse and could come with a variety of requirements related to privacy, security, encryption, expiration date, etc. For example, healthcare records must have the highest level of privacy associated with them, while data collected from public pages on the web might be available to everyone. Social media data or telephone call records and transcripts can span a variety of requirements on this continuum. In addition, the input data can represent facts, numbers or dates, where the timelines may or may not matter. Similarly, the input data can be human generated or coming from a plethora of platforms, such as Twitter®, Linkedin®, Jira® or Zendesk®, or it could be sensor data from a variety of devices, such as toasters, security cameras, or self-driving cars. A lot of this data is live data that changes over time. For example, new social media posts get created all the time. Some data sources might generate data that becomes less relevant as time goes on, or data that might even become stale with time and replaced by new information. The challenge is to be able to efficiently and continuously ingest all data and transform it to a unified representation that works well irrespective of the input data sources.

Second, various platforms and data sources store data in a variety of mediums. For example, data could be stored in a relational database or it could be stored in a data lake, or object pool, key-value store or simply as files in a filesystem.

Input data could come in a variety of modalities, such as text, images, video, audio, graphs, etc., and could also be multi-modal, with multiple of these modalities representing the same logical entity. In addition, the information density of unstructured data might often be higher than that of structured data.

Even for a single modality, data might come in different formats, each having a different representation. For example, text data can be ingested from CSV, JSON, TXT files or e-mails, word documents or binary files. Similarly, images, audio, and video data could use a variety of formats and file extensions.

Unstructured data is particularly difficult to process due to large volume, often TB of data, without any schema or data model. In addition, data might have to be cleaned before being used and multiple iterations might be necessary to understand the data and how to process it. For example, data could have duplicates and deduplicating it is not always straightforward. Unstructured data often does not have an ID, or primary key, making deduplication hard, and complicating the ability to link various pieces of related data together. In some cases, storing duplicates that occur naturally might even be desirable.

The input data might vary significantly over time, and it may do so with high velocity. Thus, it is not sufficient to ingest the data one time, but continuous or periodic ingestion might be necessary, with the appropriate checkpointing. The character of the time varying aspect of the data and how to process it, depends significantly on the input data source. Some data sources might provide updates when new data is available, making explicit which data is new or updated, while other data sources might not have a notification mechanism and polling the data source is necessary to determine if it has new data. Deduplicating new data is also data source dependent, and the ingestion process might have to filter duplicates depending on what information the data source provides. This results in a tradeoff between pulling data more often and the amount of time it takes to clean, pre-process and deduplicate data.

The disclosed connectors address these challenges by implementing data source-specific interactions when pulling the data, while providing a unified output representation for the extracted data (embeddings).

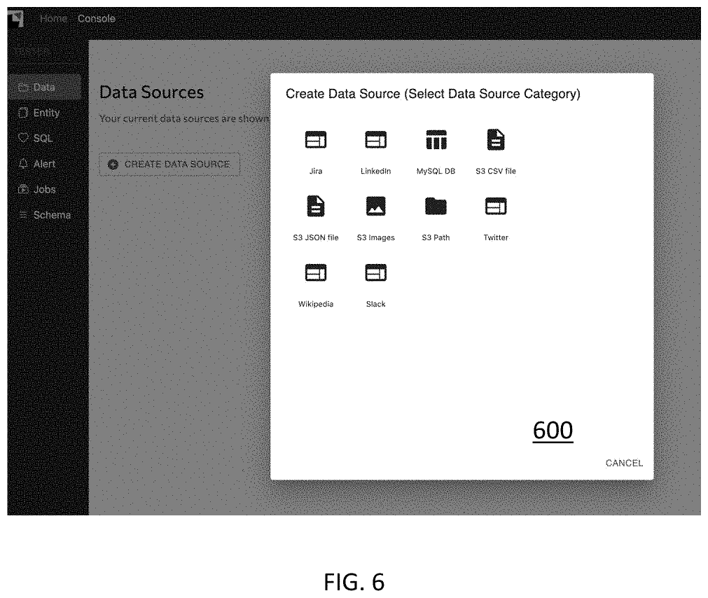

Processor 141 supplies a natural data connectors abstraction and software ecosystem. The connectors abstract any source of data that customers provide and present a unified interface to downstream pipelines using relational structures that can be queried using a familiar relational language, such as SQL. Connectors are linked to the data sources that are used to instantiate them. Example connectors and data sources include CSV files stored in S3® buckets, collections of raw S3® objects, such as images or audio files, the Twitter® connector using a Twitter® data source to extract specific user mentions or search terms, the Linkedin® Connector, etc. Such connectors may be selected from an interface 600 shown in FIG. 6.

Connectors can store the raw data, but it is not required. Their main goal is to provide access to selected metadata and vector representations of the primary data of interest. Thus, we refer broadly to data ingestion as representing two scenarios: 1) processor 141 storing both raw data and embeddings; and 2) processor 141 maintaining the data locality at the customer's site (e.g., AWS® account on node 150_1), creating a representation of the data (the “embeddings”) and storing only embeddings and any necessary metadata. This second mode, in particular, ensures that data never leaves its original location at the customer's site (private cloud or public cloud account), which enables higher data security and privacy. In addition, it safeguards against any data residency requirements that certain data might be subject to, for example data belonging to worldwide governmental organizations or certain regulated data originating in the European Union.

Users can leverage one of several different interfaces to interact with processor 141: a Web user interface, a SQL API (described in previously referenced Ser. No. 17/488,043), or a Python API. Unless explicitly noted otherwise, in the following we abstract the particulars of the interface and describe the general functionality, accessible from all the APIs.

The first step in configuring the disclosed connectors is to enable processor 141 to access user data through one or more data sources 150_1 through 150_N. A data source specification includes a unique name for the data source, data-source-specific configuration parameters and may include login credentials. For example, accessing a user provided database may require username and password, as well as hostname. Accessing an S3® bucket may require the path and extension of the objects of interest. For some data sources, login credentials might not be necessary, but data access authorization might have to be granted in advance. For example, an S3® bucket may be configured with an access point or a bucket policy that grants processor 141 the necessary permissions to access the data in the bucket.

The processor 141 maintains a schema that includes the name, configuration parameters, and login credentials (if applicable) for each data source the user creates. Once the data source has been properly configured, the data source specification is added to the project's schema, ensuring that the data source can later be accessed for downstream tasks and used to ingest data. The data remains with the user, and no data is ingested into processor 141 at this step; the configuration is stored for later access and it is used to ensure that the access has been set up correctly. As these data sources can change, the user can update the specification to reflect any changes (e.g., update login credentials when they change).

Data sources can be used to define entities or to provide labels. In addition, the specification of a data source can be used to quickly import data sources into new projects from existing projects.

Users might not always have the raw data format information on the top of their minds. One challenge with accessing Natural Data is its wide variety and heterogenous formats. Thus, processor 141 provides users the ability to preview their existing data and iterate on the connectors configurations to best match their needs. Users can preview their raw data as a reminder of the format only if they already have access to the raw data. Based on the preview, they can choose the connectors configuration parameters and see how processor 141 processes the raw data based on the configuration, allowing them to iterate if they realize a better configuration could lead to better results. For example, when connecting a CSV file, the user might not initially specify a separator to use on the CSV file. Processor 141 will make a best effort guess to use a separator, and the user can override the separator to better isolate the various streams of data in the same file. In certain cases, processor 141 could also inspect the provided Natural Data and suggest several options for configuring the connectors or given an URI could inspect and suggest all the data sources it finds. For example, given a URI for an S3® bucket, it can find existing CSV files or collections of raw objects of the same type (audio, images, etc.). To ensure good performance during the iterative process, processor 141 might maintain an in-memory cache of connected data sources. Visualization tools may aid users to make sense of the existing data before even connecting it to processor 141. Such tools may help users decide what are the primary data items that should be ingested and embedded.

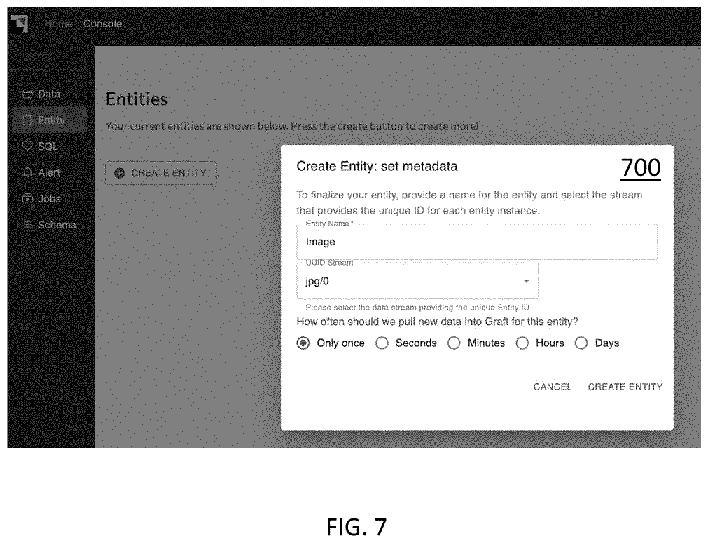

Users define entities using a simple-to-use interface by configuring a few entity parameters: name, data streams from the data sources that the user has already defined, and connector configuration, such as how often to check for new data. An exemplary interface 700 is shown in FIG. 7. Users choose which entities are important to them and define entities by grouping together relevant data from one or multiple data sources, potentially combining with data from existing entities. A user may specify only certain data within a data source, for instance three columns within a ten-column CSV file. An entity needs a unique entity name, a unique primary key column, which can be automatically generated in case it is not included in the data, and one or multiple primary data columns, which are used by the processor 141 for search or predictions. A data source could also suggest to users one or more potential entity definitions that users can adapt to their needs, if appropriate.

Similar to the data source specification, entity specifications are saved in a project schema that can be later modified or used to export the entity to new projects. The processor 141 ensures that any updates to the data source and entity specifications are atomic.

Connectors are created during entity definition, and each connector is associated with an entity, although they do not begin to ingest or transform data immediately. A primitive entity may have one or more connectors, depending on the data sources that fuel the entity. For example, an image entity created from an S3® bucket of images has a single connector that ingests the images. Once enabled, a connector runs data ingestion and may trigger embedding generation. A connector may ingest and save raw data, or it may save only the metadata, depending on the configuration. In addition, a connector may run as a one-time job, or it may be configured to run periodically on a schedule.

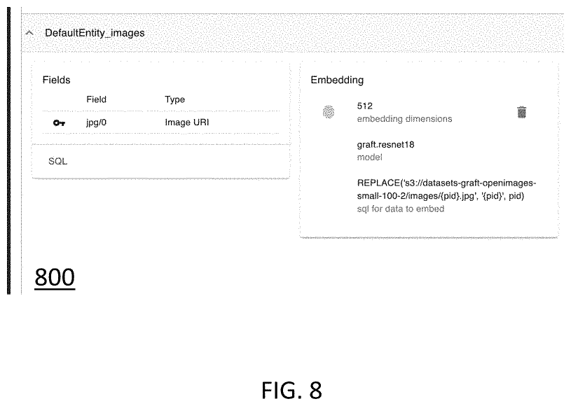

After defining entities, users define the embeddings for each entity, by choosing trunk models for embedding the raw user data. An entity may have one or more columns of primary data, which could lead to embedding generation. The user may choose to embed data using one or several trunk models, generating different embeddings. Embeddings are stored in a database and are used to create an embedding index. The system may store raw user data or only metadata and embeddings, depending on the configuration. FIG. 8 illustrates an interface 800 to define embeddings.

A user may wish to embed the same data using different trunk models. For example, text data could be embedded using a BERT model, or a T5 Model. Each trunk model used generates embeddings that are organized in their own embedding index.

A user may also wish to generate embeddings for more than one primary data column. This can be easily achieved by generating several different entities, where each entity selects a different data column to be embedded. For simplicity, the processor 141 may hide the extra steps and allow users to select multiple primary data columns to be embedded. Embeddings may also be combined in various ways to construct new aggregate entities, with their own (aggregate) embeddings.

In some cases, the user may not know the best trunk model to use when embedding data. The user may know, for example, that a transformer model should be used for text data, but not understand the difference between a BERT model and a DistilBERT model. Processor 141 can make an educated guess as to the best model to use using simple heuristics or more complex methods to intelligently select the appropriate trunk model. One such heuristic is to choose the model which maximizes the entropy of the user's dataset.

If requested by the user, processor 141 can do additional training steps for the trunk models, using the user data after it has ingested. This process generates a new trunk model and leads to updating embeddings and any other artifacts that are generated based on embeddings (e.g., indexes, predictions, etc.).

After the connectors ingest data and trigger embedding generation, embeddings are stored in a database with the entity metadata and raw user data (if applicable). Thus, they are accessible via SQL and they allow standard SQL and Graft-SQL operations. For fast retrieval and kNN search, embeddings are also organized using an embedding index.

Connectors are high-level user-visible jobs that are scheduled by the job scheduler (shown as operation 204 in FIG. 2). Connectors can be scheduled to ingest data from a data source on demand (by the user), periodically on a schedule (e.g., every day) or using a data source-specific new data notification mechanism (e.g., a trigger for a database data source). The connector job runs the data ingestion from a data source, storing the raw data in a database (if applicable), and triggering the embedding job for the ingested data. The scheduler may decide to postpone embedding generation if the connector ingested only a small amount of new data, and batch multiple data updates, based on the load on the system. The job scheduler decomposes the high-level ingestion and embedding jobs into lower-level tasks, creates a dependency graph between the tasks with a common sink node to aggregate the results of partial steps in the task graph (one sink for each higher-level job) and sends the task graph to one or more task schedulers, which assign the tasks to workers (i.e., machines in network 100) according to the task graph and resources required.

While Connectors trigger downstream jobs when ingesting new data, such as embedding generation, these downstream jobs can also be triggered by other events, such as trunk model changes.

While some data sources might have static data, most data sources generate live data that grows or evolves over time. Connectors are configurable to decide how often to ingest new data. One option is that connectors run on a schedule, with the job scheduler driving the updates according to the configuration. Another option, if the data source supports it, is that the data source itself generates a notification when new data is available and the connector ingest the new data.

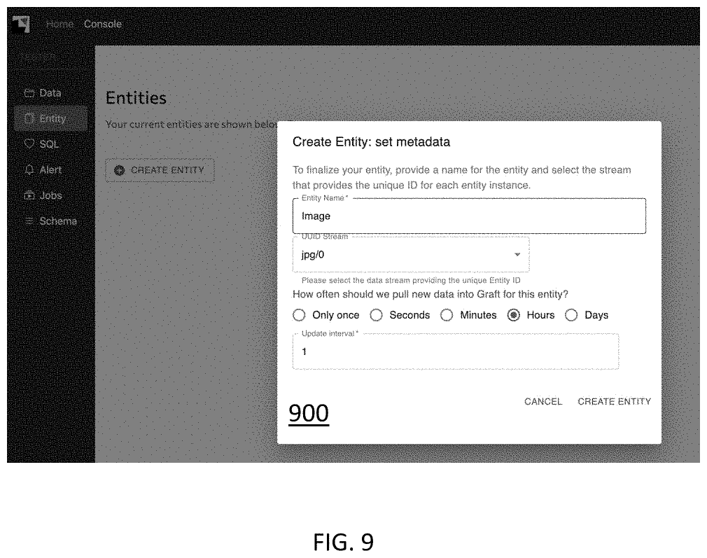

Connectors that detect new incoming data (either through notifications or through periodic polling) must ensure data deduplication. Such deduplication is data source dependent: the data source could send all new data since the last ingestion. If the data source does not have this mechanism, it might use a timestamp to detect what is the new data, or the connector might have to deduplicate data locally by relying on unique primary keys, or even on the proximity of the generated embeddings. FIG. 9 illustrates an interface 900 to specify an hourly sequence to pull new data from an entity named “Image”.

The processor 141 enables users to define and fine-tune enrichments based on labeled entity data. To label entity data, processor 141 employs a similar mechanism to regular data definition and ingestion: the labeled data is defined through one or more data sources and can be ingested through connectors.

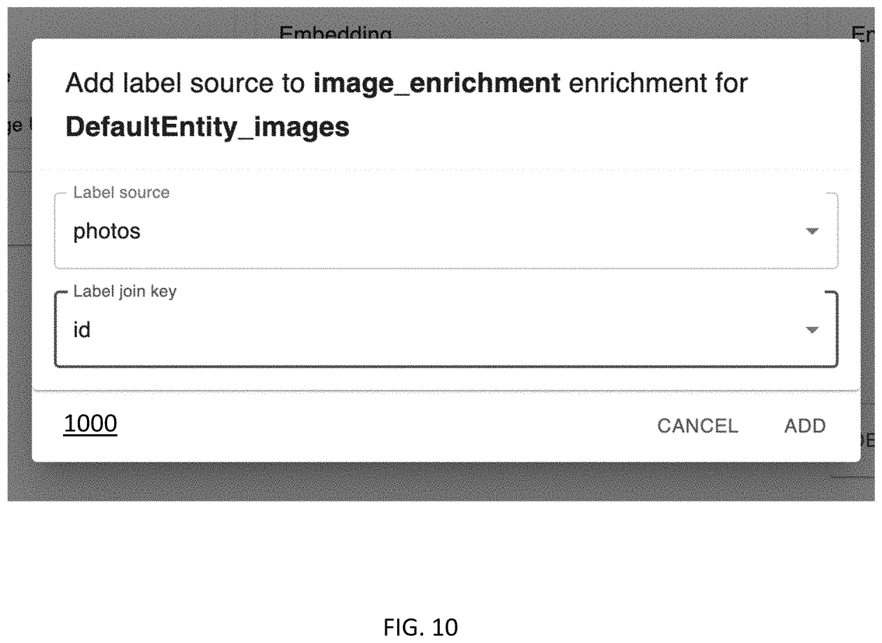

Users can also provide ad-hoc labels, where they change existing label values or provide new labels for unlabeled data by-value, instead of referencing a data source. FIG. 10 illustrates an interface 1000 that may be used in accordance with an embodiment of the invention.

Before connectors can start ingesting data and triggering embedding generation, the processor 141 needs to authenticate users and determine which data they are authorized to access. Users might be authorized to add data sources from specific data, but without having the access to actually see the data. In this case, these users will be able to set up the data source configuration and see the resulting data source schema to ensure that the data has been correctly configured, but they might not be able to preview the specific data being ingested from a data source. Similarly, some users might not even be able to configure data sources, but they might still be able to define entities based on the data. Finally, processor 141 ensures that users who do not have access at all to certain data cannot define data sources or entities based on unauthorized access.

Traditional connectors provided by other companies do not address the problems listed above. These connectors focus on raw data ingestion, primarily from data sources that provide structured data, often as a one-time ingestion process. Examples include Fivetran®, DataCoral®, and OriginLab® data connectors. Similarly, Kafka® (source) connectors offer data streaming and interoperability with Kafka®, with Confluent® providing a fully-managed version of these connectors with an elastic cluster infrastructure. Similarly, all the major cloud providers (AWS®, Azure®, Google®) enable data connectors access to their various cloud-based sources of data, such as logs, monitoring, databases, etc.

In contrast, the disclosed connectors pull in natural data, which can consist of both structured and unstructured data, potentially on a periodic refresh schedule (live data) and convert the raw data into a learnable vector representation (embeddings).

Other data connectors, such as Datapine® and Stitch® data connectors, focus primarily on a uniform, centralized data collection platform, which extracts and loads the data into a data lake or warehouse.

The disclosed connectors may ingest data or may work seamlessly with customer data wherever the data is located, ingesting only the vector representation for future search and analysis.

An embodiment of the present invention relates to a computer storage product with a computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using JAVA®, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A non-transitory computer readable storage medium with instructions executed by a processor to:
maintain a collection of data access connectors configured to access different sources of unstructured data;
supply a user interface with prompts for designating a selected data access connector from the data access connectors;
receive from the selected data access connector unstructured data;
create from the unstructured data numeric vectors characterizing the unstructured data; and
store and index the numeric vectors.

2. The non-transitory computer readable storage medium of claim 1 further comprising instructions executed by the processor to manage credentials and authorization to control access to the different sources of unstructured data.

3. The non-transitory computer readable storage medium of claim 2 wherein the credentials include a data source and data source specific configuration parameters.

4. The non-transitory computer readable storage medium of claim 3 wherein the credentials include login credentials.

5. The non-transitory computer readable storage medium of claim 3 wherein the credentials include role-based credentials.

6. The non-transitory computer readable storage medium of claim 3 wherein the credentials include policy-based credentials.

7. The non-transitory computer readable storage medium of claim 1 further comprising instructions executed by the processor to apply embedding models to form the numeric vectors.

8. The non-transitory computer readable storage medium of claim 7 wherein the embedding models are user specified.

9. The non-transitory computer readable storage medium of claim 7 wherein the embedding models are automatically designated.

10. The non-transitory computer readable storage medium of claim 1 wherein the prompts include a data source prompt and a data access periodicity prompt.

11. The non-transitory computer readable storage medium of claim 1 wherein the prompts include a prompt to receive from the selected data access connector unstructured data upon a change in source data.

12. The non-transitory computer readable storage medium of claim 1 further comprising instructions executed by the processor to support semantic searches of the numeric vectors.

13. The non-transitory computer readable storage medium of claim 1 further comprising instructions executed by the processor to predict labels.

14. The non-transitory computer readable storage medium of claim 1 further comprising instructions executed by the processor to issue alerts when specified criteria are satisfied.

15. The non-transitory computer readable storage medium of claim 1 further comprising instructions executed by the processor to suggest options for configuring the selected data access connector.

16. The non-transitory computer readable storage medium of claim 1 further comprising instructions executed by the processor to form a task dependency graph including the selected data access connector and an embedding task.

17. The non-transitory computer readable storage medium of claim 16 wherein the task dependency graph specifies tasks that are distributed to different machines in a network.

18. The non-transitory computer readable storage medium of claim 1 further comprising instructions executed by the processor to invoke different data access connectors to preview a data source prior to designating the selected data access connector.

19. The non-transitory computer readable storage medium of claim 1 further comprising instructions executed by the processor to alternatively execute the selected data access connector on-demand by a user, periodically in accordance with a schedule or in response to new source data.
